(19) United States
(12) Patent Application Publication
(10) Pub. No.: US 2008/0014899 A1
(43) Pub. Date: Jan. 17, 2008

(54) Wireless communication device and system

(76) Inventor: Richard H. Day, Germantown, MD (US)

Correspondence Address: WELSH & KATZ, LTD, 120 S RIVERSIDE PLAZA, 22ND FLOOR, CHICAGO, IL, 60606, US

(21) Appl. No.: 11/484,391

(22) Filed: Jul. 11, 2006

(51) Int. Cl. H04M 11/04

(52) U.S. Cl. 455/404.1

(57) ABSTRACT

A wireless communication device includes a mode wherein an incoming communication is placed on hold and a verbal response message is sent to the initiator of the communication. A non-audible tactile or visual indicator is provided at the device indicative of the presence of an incoming communication.

### FIELD OF INVENTION

The invention pertains to wireless communication devices and systems. More particularly, the present invention pertains to such devices and systems which can automatically place an in-coming communication into a pending, or hold, status until it can be answered.

### BACKGROUND OF THE INVENTION

The ease of communication provided by wireless communication devices such as cell phones or PDAs or the like can at times create their own difficulties. For example, it is not unusual for wireless devices such as cellular telephones to be set to emit audio ringing tones, as well as inaudible vibratory tones or visual indicators of incoming calls. Depending on the environment these audio tones can not only be distracting but they can create both business and social problems.

A partial solution is provided with respect to various devices by turning off the device completely or by turning off the audible incoming call indicators. In these instances even though the audible call indicating tones may cease to be a problem, the device user or owner has to decide whether to respond to a vibrating or blinking device, which might be occurring at a very inconvenient time for business or social reasons, or to allow the call to go into his or her voicemail or simply ignore it.

Even where the individual would like to respond to the incoming communication, it may be necessary to go to a different area to answer the call. At times of course before the individual can answer the call, the calling party hangs up or terminates the call without necessarily leaving a message.

There thus continues to be an ongoing need for more flexible ways to address incoming calls or other communications at times or in circumstances where the incoming call or communication cannot be responded to immediately. Preferably such functionality could be incorporated into known types of wireless devices and cellular phones, for example, or at least in part into telephone switching systems without having to make substantial or extensive hardware modifications to the respective devices or telephones. It would also be desirable to provide feedback to the party initiating the communication as to the status of the receiving wireless device as well as the availability of the callee to respond to the incoming communication.

### BRIEF DESCRIPTION OF THE DRAWINGS

FIG. 1A is a block diagram of a wireless device in accordance with the invention;

FIG. 1B is a block diagram of a wireless communication system in accordance with the invention;

FIGS. 2A, 2B taken together are a flow diagram of a method in accordance with the invention; and

FIGS. 3A-3D taken together are a flow diagram of an alternate method in accordance with the invention.

### DETAILED DESCRIPTION OF THE INVENTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

Communications systems or wireless devices which embody the present invention incorporate a capability to respond to an incoming communication with a predefined or predetermined message indicating that the owner or user of the respective device, the callee, is presently in a “quiet zone” and will be answering shortly but not immediately. In this mode of operation the call is not terminated after sending a response message. Instead, the incoming communication or call is placed in a pending, unanswered status, such as being placed on hold

In one aspect of the invention, the device can notify a recipient that an incoming call has arrived via a non-audible indicator such as by vibrating or flashing a display or the like. The callee can in one mode of operation either ignore the incoming call or alternatively, activate a “quiet answer” feature.

If the quite answer feature is activated, a predetermined message is transmitted to the source of the incoming communication indicating that the recipient is presently unable to respond to the communication but will be able to do so shortly. The incoming communication is then placed in a pending status or on hold. This embodiment of the invention provides an opportunity for the recipient to leave the location where he or she is presently located for a different location where the incoming communication can be answered or responded to. The keyboard of the wireless device or cellular telephone can be used to activate the quite answer feature as well as to pick up or answer the incoming call which has been placed on hold.

In yet another aspect of the invention, when the device is in a predetermined or selected mode of operation, it will respond to incoming communications automatically with a predetermined message or signal informing the source of the incoming communication that the intended recipient is currently unable to respond but expects to be able to respond to the call shortly. In accordance with this embodiment of the invention, the device can continue to notify the recipient by means of a non-audible indicator such as vibration or a visual display or both.

In yet another embodiment, the user of the device can enable a feature that forms one or more groups of numbers i.e. user Id's, which the user has previously edited or constructed. These groups of user Id's can be enabled or disable as desired. If a user of the device enables the group mode and one or more groups are enabled then the device goes into a ‘Selective Quiet Mode’ of operation. When the device is in the ‘Selective Quiet Mode’ of operation, if someone calls the user of the device that is not in one of the enabled groups, in one embodiment, the device acts as though it is turned off and responses accordingly. However, if an incoming call is from a source which is in one of the selected groups that is/are enabled, then the device acts as though it is in the ‘Automatic Quite Mode’ of operation. Other variations come within the spirit and scope of the invention.

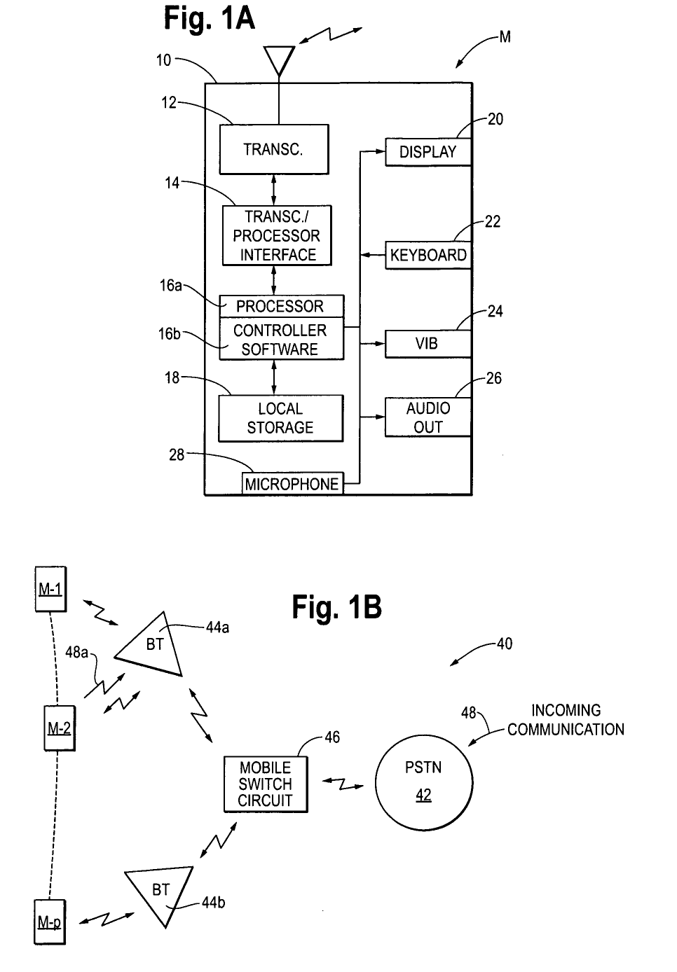

FIG. 1A illustrates in block diagram form a wireless or cellular telephone M. It will be understood that the subsequent discussion is not limited to cell-type wireless telephone devices.

Embodiments of the invention could be incorporated into wireless enabled personal computers, wireless personal digital assistants (PDAs) as well as devices which provide much more extensive services than wireless telephones such as personal communications services (PCS) type devices. Further those with skill will understand that the details of any wireless communication protocol with which the unit M might operate are not limitations of the present invention.

The unit M includes a housing 10 which carries a wireless or RF transceiver 12. A transceiver interface 14 can be provided to facilitate bi-directional communications with a control processor or processors 16a and associated control software 16b. As will be understood by those with skill in the art, local storage 18 can also be provided, coupled to the processor or processors 16a. Characteristics and nature of the storage unit or devices 18 are not limitations of the present invention. The storage unit 18 could be implemented in part with read/write read-only memory, or, programmable read-only memory, all without limitation. Some or all of the control software 16b could be stored in device 18.

Unit M also includes a visual, usually two-dimensional, display unit 20 which can be driven processor or processors 16a to present alpha-numeric or pictorial displays or both all without limitation. A keyboard 22 is provided to enable the user to enter text, numerals or commands as appropriate. The housing 10 can also carry a vibratory unit 24 which can be activated by the processor or processors 16a to indicate to a user, or callee, the presence of an incoming communication. Audio outputs, ring tones or speech, can be provided by an audio transducer, for example, a loud speaker, 26. Input audio can be coupled via a microphone 28 to the processor or processors 16a.

FIG. 1B illustrates a plurality of units, M-1, M-2, M-p, such as a unit M interacting with a wireless communication system 40. A wireless unit such as the unit M-m can communicate bi-directionally with a public switched telephone network 42 through the use of spaced apart cell, or, base transceivers such as 44a, b in conjunction with a mobile switching center 46. Those of skill in the art will understand that none of the details associated with the transceivers 44a, b neither the mobile switching center 46, nor the telephone network 42 represent limitations of the present invention.

As discussed above, embodiments of the invention make it possible for a mobile unit, such as the exemplary mobile unit M-m, to respond to an incoming communication 48, for example, from an individual received from a land line telephone or another wireless unit. The subject communication 48 is directed to the respective mobile unit M-m. In response thereto, the mobile unit M-m, when in a selected mode, can cause a reply communication 48a to be sent to the originator of the incoming communication 48 indicating that the callee at the unit M-m is presently unavailable to respond to the incoming communication but expects to be able to do shortly. The incoming communication can then be placed on hold for a period of time until either the originator terminates the communication, or, the recipient is able to respond thereto. Alternately, the communication 48a can direct the switching center 46 and/or a central office of the network 42 to respond to the communication 48.

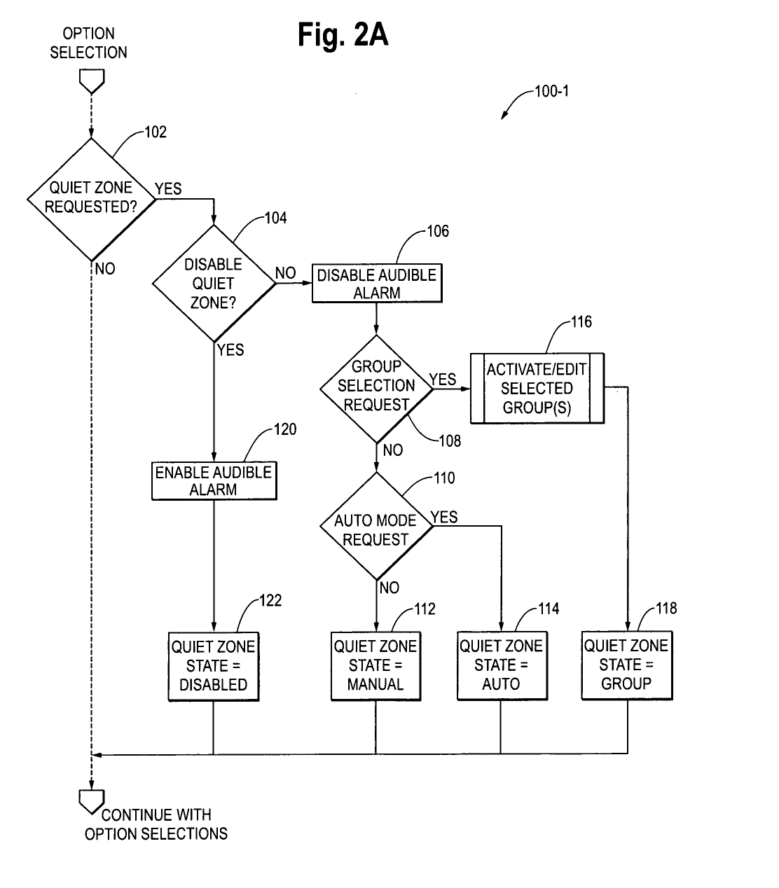

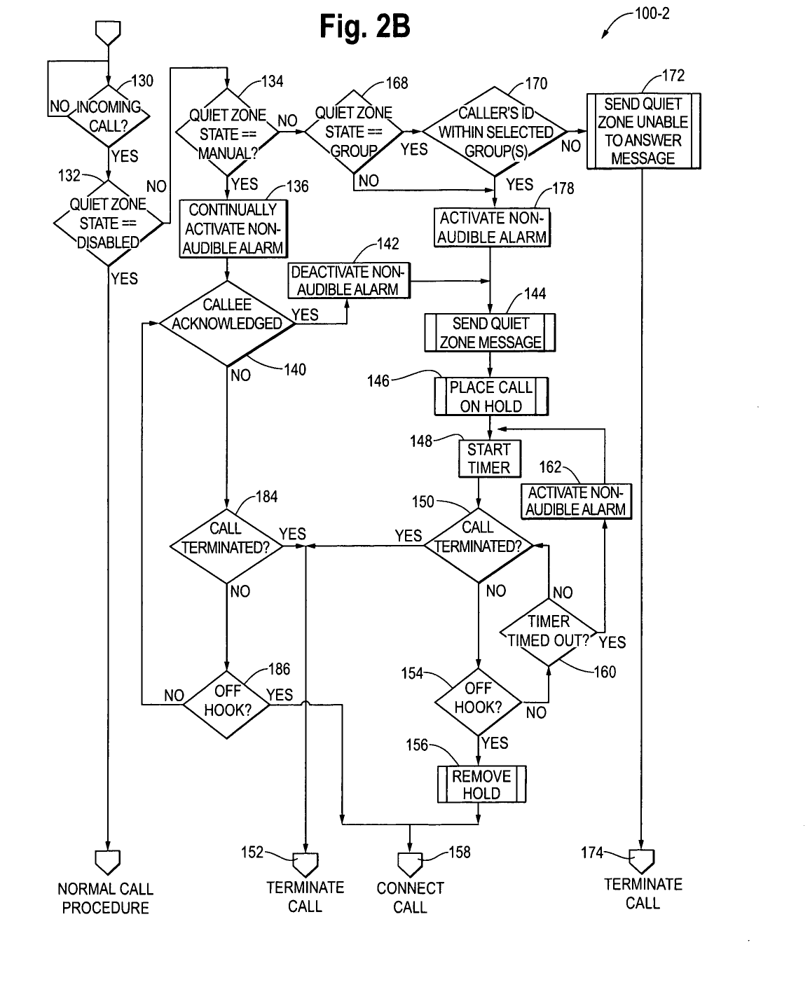

FIGS. 2A, 2B illustrate aspects of a method 100 in accordance with the present invention. In accordance with method 100, the above described functionality is primarily implemented at a mobile unit such as the mobile unit M.

The subject functionality can be selected by a user of the unit M, in an exemplary embodiment, by selecting it as an option. Where the quiet zone option is selected, see FIG. 2A step 102, and it is not being disabled, step 104 the audible alarm device, for example, output transducer 26, can be disabled, step 106. If a group selection request is not being made, step 108 a determination is made as to whether the requested quiet zone response should be automatic or manual, step 110. Selected manual status can be stored, step 112. Selected automatic status can be stored, step 114.

Where a group or groups is, or, are to be selected at step 108, one or more groups can be activated or edited step 116. A group designation status indicator can be stored step 118. Other options can then be selected as needed.

FIG. 2B is a flow diagram indicating steps 100-2 of the method 100 which are carried out in implementing the above-noted functionality. In response to a detected incoming call step 130 a determination is made as to whether the quiet zone functionality, specified in method steps 100-1, has been disabled. If so, normal call processing is carried out by the unit M. If not, in step 134 a determination is made as to whether or not the manual status had been previously selected, step 112. If so, in step 136 a non-audible alarm, such as the vibratory element 24, or a portion of the display 20 can be activated.

If the incoming communication is acknowledged by the callee, for example by depressing a selected key on the keyboard 22, step 140 the non-audible alarm unit is deactivated step 142. The unit M then transmits a pre-stored quiet zone message step 144 to the initiator of the incoming communication 48. The received communication is then placed into a pending or hold state 146.

A time interval can then be initiated step 148.

A determination is made step 150 as whether or not the party initiating the call has terminated same. If so, termination processing 152 is executed. If not, a determination is made, step 154 as to whether the callee, the intended recipient of the communication has “answered the communication”, and taken the respective wireless unit M-m “off-hook”. If so, in step 156 the “hold” status of the communication is removed and the communication is connected step 158.

In the event that the determination in step 154 is negative, a further determination is made as to whether the timer has timed out, step 160. If so, the non-audible alarm, such as the vibratory unit 24 can be activated again, step 162.

As alternate processing, a determination is made in step 168 as to whether group status had previously selected. If so, in step 170 a determination is made as to whether the identification of the caller associated with the incoming communication 48 is within the selected group or groups. If not, in step 172 a previously established quiet zone “unable to answer message’ is returned to the initiator of the communication 48 and the call is then terminated step 174.

Alternately, where the caller's ID is within the selected group or groups the non-audible alarm element, such as vibratory element 24 is activated, step 178, and call processing proceeds as previously discussed.

Alternately, in the absence of acknowledgement from the callee, step 140, a determination is made as to whether the call has been terminated step 184. If not, a determination is made step 186 as to whether the callee has responded with an indication that he or she wishes to initiate or respond to the incoming communication 48. In this instance call connect processing is then commenced as in step 158.

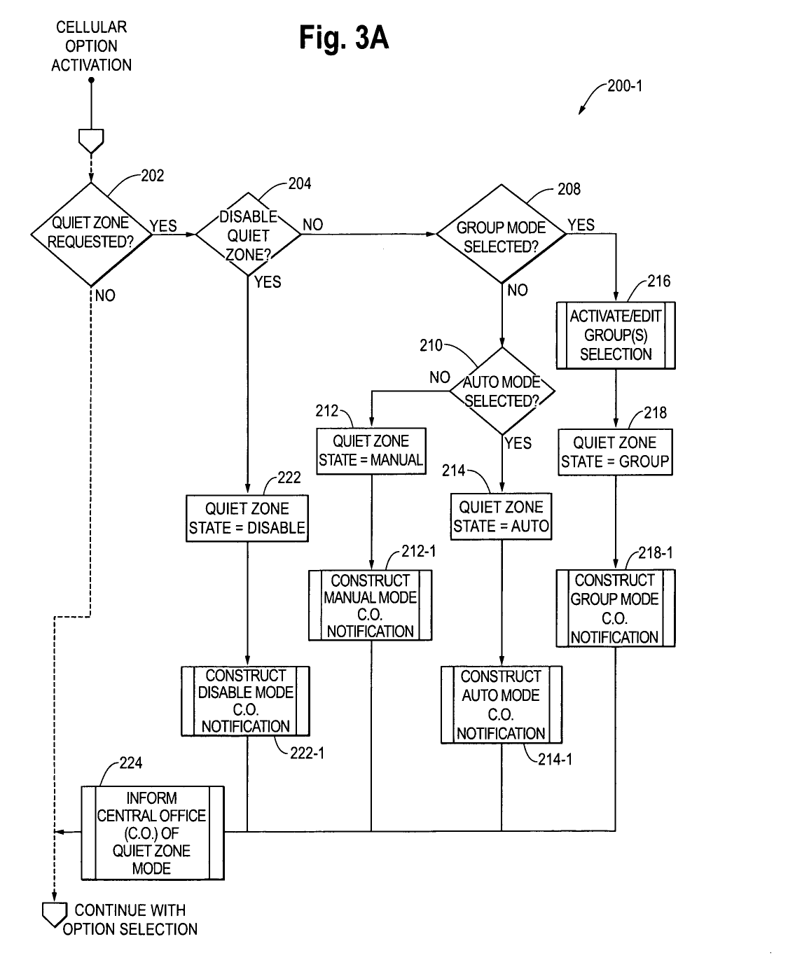

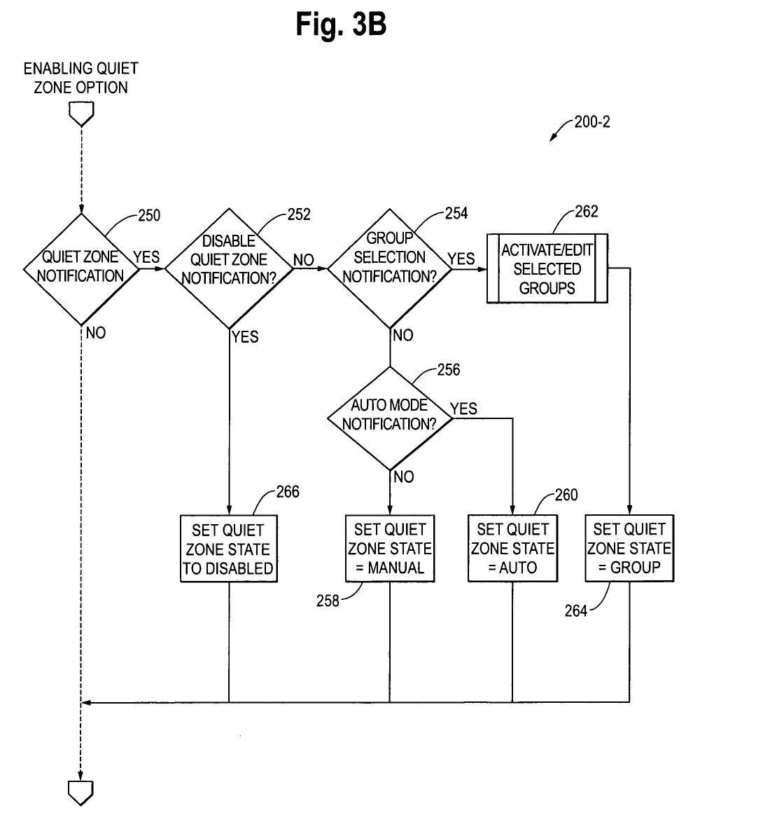

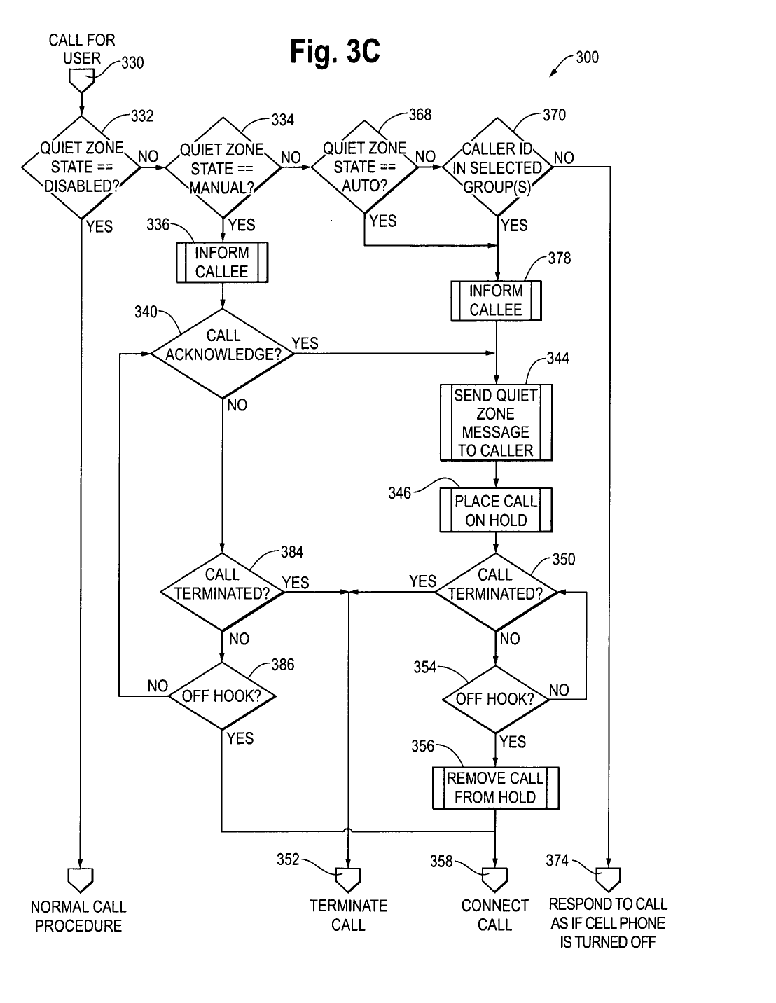

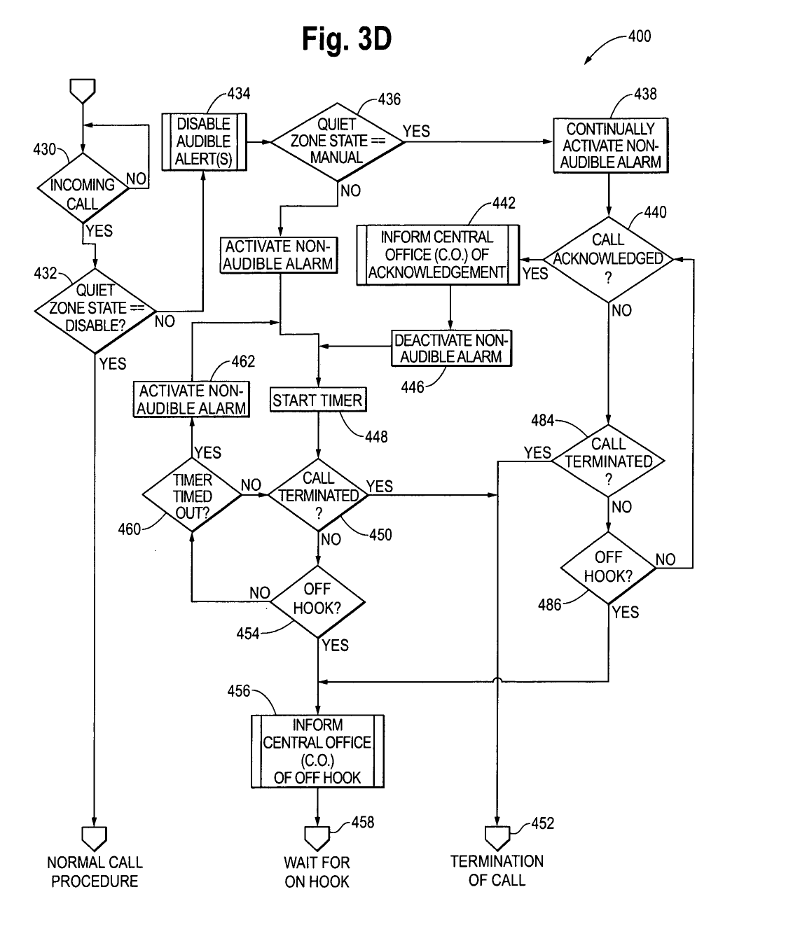

FIGS. 3A-3D illustrate an alternate method 200 in accordance with the invention. In the processing of FIGS. 3A-3D at least portions of the circuitry and/or software for implementing functionality as described previously with respect to FIGS. 2A,2B can be located in part in the mobile switching center 46 and/or in portions of the public switched telephone network 42, for example in the appropriate central office thereof. The location of such software and/or hardware is not a limitation of the invention.

FIG. 3A illustrates steps 200-1 associated with selecting the quiet mode option at a respective wireless unit M-m. In a step 202 a determination is made as to whether or not quiet zone functionality has been requested. If so, a determination is made as to whether that functionality should be disabled in step 204. If not, in step 208 a determination is made as to whether a group mode of operation has been selected. If not, a determination is made in step 210 as to whether the auto mode has been selected. If not, in step 212 quiet zone status is set to manual. If so, in step 214 quiet zone status is set to auto. Subsequently in steps 212-1 and 214-1 messages are created to notify the mobile switching center 46 and/or central office associated with the switching center 46 of the selected state.

In the event that the group mode functionality has been selected in step 208, in step 216 the wireless unit user is enabled to activate and/or edit one or more groups which are to be associated with the quiet zone functionality. The keyboard 22 and/or display 20 can be used to create or edit groups.

In step 218 the quiet zone status is set to group. Subsequently in step 218-1 a message is created to notify the mobile switching center 46 and/or the relevant central office as to the elected group status.

If a determination has been made in step 204 to disable the quiet zone functionality, in step 222 the status thereof is set to disable. In step 222-1 a message is generated to be forwarded to the mobile switching center 46 and/or relevant central office. In step 224 the relevant status message is forwarded.

FIG. 3B illustrates steps 200-2 carried out wholly or in-part at the mobile switching center 46 and/or the relevant and associated central office of the public switched telephone network 42 in response to the option selection of FIG. 3A. In step 250 a determination is made as to whether a quiet zone option selection notification, message or command has been received from a respective wireless unit such as a unit M-m. If so, a determination is made in step 252 as to whether the quiet zone functionality has been disabled. If not, a determination is made in step 254 as to whether a group mode of operation has been selected. If not, in step 256 a determination is made as to whether the auto mode has been selected. If not, the quiet zone functionality indicator for the relevant wireless unit is set to manual, step 258. If so, the quiet zone functionality indicator for the relevant wireless unit is to set to auto, step 260.

Where the group mode has been selected, step 254 the selected groups can be established, step 262. The status indicator can then be set step 264.

Where the quiet zone functionality has been disabled, step 252, the status indicator is set to reflect that condition, step 266.

FIG. 3C illustrates steps 300 associated with quiet zone processing at the mobile switching center 46 and/or associated central office of the public switch telephone network 42. Where an incoming call 330 has been sensed, in a step 332 a determination is made as to whether the quiet zone function has been disabled. If not, a determination is made as to whether the quiet zone state has been set to manual, step 334. If so, the recipient or callee is notified, for example, by forwarding a signal or message to activate vibratory element 24, step 336. In a step 340 a determination is made as to whether the callee has acknowledged the presence of the incoming call. If so, a predetermined quiet zone message is sent to the caller, or source of the communication, step 344. The incoming call is then placed on hold or, in a pending status, step 346.

A determination is made in step 350 as to whether the call has been terminated. If so, call termination processing 352 is executed. If not, a determination is made as to whether the respective callee has responded to the non-audible indicator by answering the call, step 354. If so, the call is removed from hold, step 356 and connection processing is executed, step 358 to establish a bi-directional communication channel between the caller associated with the incoming call 48 and the callee at the mobile M-m identified thereby.

If in step 370 the caller ID is not in one of the selected groups, the mobile switching center 46 and/or the associated central office of the public switched telephone network 42 processes the call as if the respective mobile unit has been turned off, step 374. If the callee ID is in one of he selected groups, the callee is notified as above, step 378 and processing continues.

Where the determination has been made that the call had not been acknowledged, step 340, a determination is then made if the call has been terminated, step 384. If so, termination processing, step 352, is executed. Otherwise, a determination is made as to whether the callee wishes to receive the incoming communication 46 by responding thereto, step 386. If so, call connect processing is executed, step 358.

FIG. 3D illustrates steps 400 are carried out at the wireless unit such as the unit M-m in response to processing 300 of FIG. 3C.

In response to detecting an incoming call, step 430, the wireless unit determines whether or not the quiet zone functionality has been disabled, step 432. If not, audible indicia ring tones and the like, normally associated with an incoming communication are disabled, step 434. A determination is then made step 436 as to whether the quiet zone status has been set to manual. If so, the respective mobile unit, such as M-m, continually activates the non-audible alarm, for example the vibratory unit 24, step 438.

In step 440 a determination is made as to whether the incoming call has been acknowledged. If so, a message is sent informing the mobile switching center 46 and/or respective central office of the public switched telephone network 42 of the acknowledgment, step 442. The mobile unit then deactivates the non-audible alarm indicator 24, step 446.

A time interval is then established by starting a hardware and/or software timer in the wireless unit M-m step 448. A determination is made in step 450 as to whether the incoming communication or call has been terminated. If not, a determination is made in step 454 as to whether the mobile unit M-m has been directed by the callee to respond to the incoming communication and go off-hook. If so, a message is then forwarded to the mobile switching center 46 and/or respective central office of the telephone network 42, step 456. Communications are then established between the source and the callee with respect to the incoming call 48, step 458.

Where there is no indication, by action of the callee, that the mobile unit is to respond to the incoming call, step 454, a determination is made in step 460 as to whether the timer has timed out. If so, in a step 462 the non-audible alarm indicator 24 can be activated again.

In the event that the call has not been acknowledged, step 440 a determination is made, step 484, as to whether the call has been terminated. If so, termination processing is executed, step 452. If not, a determination is made, step 486 as to whether the respective unit has gone off-hook and indicated that the incoming communication 48 should be forwarded. If so the central office is notified, step 456 and a communication path established.

Those with skill with understand that whether some or all of the above-described functionality is located at the mobile switching center 46 as opposed to the relevant switching center or central office of the telephone network 42 is not a limitation of the present invention. Further, it will be understood that the above-described functionality could be implemented using various combinations of hardware and software all without limitation.

It will also be understood that the quiet zone status message fed back to the caller could be stored at the mobile unit M-m, at the mobile switching center 46 or at the telephone network 42 all without limitation. That message could be established and changed by the callee at the unit M-m.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. An apparatus comprising:
at least one wireless, portable communications unit;
a wireless communication system that couples communications between the unit and a displaced communications source;
circuitry located at least in part at the unit and at the system which, when in a selected mode, responds to a communication from a source directed to the unit by returning a verbal informational status reply to the source, emitting a non-audible indicator from the unit, and by placing the communication into a pending state.

2. An apparatus as in claim 1 which includes storage for a plurality of identifiers of sources to which the verbal status reply can be sent.

3. An apparatus as in claim 2 which includes software to specify the members of the plurality.

4. An apparatus as in claim 2 which includes software to enter and store the verbal status reply.

5. An apparatus as in claim 4 which includes software to specify the members of the plurality.

6. An apparatus as in claim 5 which includes mode specifying software with one mode that automatically returns the verbal communication and another mode which emits the non-audible indicator and waits to receive a manually generated input prior to returning the verbal communication.

7. An apparatus as in claim 6 where the unit includes a manually operable input device with which the verbal status reply can be entered.

8. An apparatus as in claim 6 where the unit includes a manually operable input device with which the members of the plurality can be entered.

9. An apparatus as in claim 4 where the software is located, at least in part, at one of the wireless unit, or, the system.

10. An apparatus as in claim 1 which includes a plurality of pre-stored source identifiers to which the verbal status reply can be returned.

11. A wireless communications device comprising:
a wireless transceiver;
multi-mode control circuitry coupled to the transceiver, the circuitry, when in a selected mode, responds to a received wireless communication by transmitting, via the transceiver, an informational reply and placing the communication into a pending state until an additional reply can be provided.

12. A device as in claim 11 which includes a storage circuit coupled to the control circuitry, a representation of the informational reply is retained in storage circuit.

13. A device as in claim 11 where the control circuitry includes software to, at least in part, respond to the communication and place the communication into the pending state.

14. A device as in claim 13 which includes at least one of a visual or a tactile indicator of the received communication.

15. A device as in claim 14 where the software, responsive to the communication, activates the received communication indicator.

16. A device as in claim 15 that includes further software which, responsive to a command signal, couples the pending communication to an output device.

17. A device as in claim 15 that includes additional software to transmit the informational reply via the transceiver to the source of the received communication.

18. A device as in claim 11 which includes a list of identifiers of received communications to which the control circuitry responds by transmitting the informational reply.

19. A device as in claim 17 which includes a manually operable control member to place the control circuitry into the selected mode.

20. A device as in claim 17 which includes further software to respectively activate the received communication indicator.

21. A device as in claim 16 where the output device comprises an electrical-to-audio transducer.

22. A device as in claim 11 where the control circuitry responds to a received wireless communication by one of, initiating a communication process when in a first mode, transmitting the informational reply and placing the received communication into the pending state when in the selected mode, or, transmitting a second informational reply and terminating the received communication when in a second mode.

23. A device as in claim 22 which includes mode establishing circuitry, the mode establishing circuitry is responsive to an externally initiated mode specifying input.

24. A device as in claim 23 where the first mode corresponds to an immediate communications mode, the selected mode corresponds to an automatically deferred communications mode for received communications.

25. A method comprising:
sensing the arrival of an incoming communication for a callee;
determining that the communication needs to be held for an interval and, responsive thereto, verbally, or visually replying to a source of the communication;
placing the received communication into a pending state; and
notifying the callee, non-audibly of the communication.

26. A method as in claim 25 which includes removing the communication from the pending state and coupling the communication to the callee.

27. A method as in claim 25 which includes establishing a plurality of sources whose communications need to be held.

28. A method as in claim 27 where determining includes, for communications from members of the plurality of sources, verbally replying to the respective source before placing the communication into a pending state.

29. A method as in claim 25 where placing comprises placing a received communication on hold.

30. A wireless communications device comprising:
a keyboard;
a wireless transceiver;
an audible output transducer and at least one non-audible output transducer;
control circuitry including a programmable processor and associated control software, the control circuitry which has at least first and second modes of operation is coupled to the keyboard, the transceiver and the transducers, and is responsive to an incoming communication, when in the first mode one transducer emits an audible indicia thereof, and, when in the second mode, the other transducer locally emits a non-audible indicia thereof, and places the communication in to a waiting state.

31. A device as in claim 30 where the software, at least in part, forwards a predetermined mode indicating verbal or text message to a source of the incoming communication.

32. A device as in claim 30 which includes an audio input transducer, the software, responsive to a selected control signal, removes the communication from the waiting state thereby providing an audio communications path between the input transducer and a source of the communication.

33. A device as in claim 32 where the keyboard includes at least one manually operable member for producing the selected control signal.

34. A device as in claim 33 where the control software, when in the first mode, responds to a second control signal and at least in part establishes the audio communications path between the input transducer and the source of the communication.
